(19) United States
(12) Patent Application Publication
(10) Pub. No.: US 2003/0138028 A1
(43) Pub. Date: Jul. 24, 2003

(54) Wafer temperature detection device for ion implanter

(76) Inventors: Seiji Takayama, Futtsu City (JP); Takayuki Yano, Futtsu City (JP); Satoshi Suzuki, Futtsu City (JP); Kazuo Mera, Ibaraki (JP); Hiroyuki Tomita, Ibaraki (JP)

Correspondence Address: Wenderoth Lind & Ponack LLP, 2033 K Street NW, Suite 800, Washington, DC, 20006, US

(21) Appl. No.: 09/549,492

(22) Filed: Apr. 14, 2000

(30) Foreign Application Priority Data
Apr. 16, 1999 (JP) 11-110005

(51) Int. Cl. G01K 1/00

(52) U.S. Cl. 374/208; 374/31

(57) ABSTRACT

A wafer temperature detection device for an ion implanter including a dummy and a temperature detector. The dummy is disposed on a rotating disk where wafers are disposed to have ions implanted in the ion implanter and is made of a substantially identical material as that of the wafers. The temperature detector is provided on the dummy.

### BACKGROUND OF THE INVENTION

1. Field of the Invention

The present invention relates to a temperature detection device for wafers disposed in an ion implanter.

2. Description of Related Art

An ion implanter is a device for implanting ions into wafers by radiating an ion beam under a vacuum condition using a current of 10 mA to 100 mA, for example. The wafers are disposed on a rotating disk provided in the ion implanter. The disk is rotated and oscillated at the same time, while the scanning spot of the ion beam is moved in either mechanical or electromagnetic manner.

The wafer temperature has hitherto been measured with a non-contacting temperature detector such as an infrared radiation thermometer. For example, the operator measures the radiation temperature peeping through a small window provided on the ion implanter.

However, due to clouding of the small window and the fact that the disk where the wafers are disposed is rotating at a high speed, the temperature measurement based on the radiation temperature presents a problem that it may not necessarily provide accurate measurements.

### SUMMARY OF THE INVENTION

It is an object of the present invention to provide a device capable of accurately detecting in situ the temperature of wafers disposed in an ion implanter.

It is still more specific object of the invention to provide a wafer temperature detection device for an ion implanter including a dummy and a temperature detector. The dummy is disposed on a rotating disk where wafers are disposed to have ions implanted in the ion implanter and is made of a substantially identical material as that of the wafer. The temperature detector is provided on the dummy.

The objects, characteristics, and advantages of this invention other than those set forth above will become apparent from the following detailed description of the preferred embodiments, which refers to the annexed drawings.

### BRIEF DESCRIPTION OF THE DRAWINGS

FIG. 1 is a schematic illustration of assistance in explaining a wafer temperature detection device for an ion implanter according to an embodiment of this invention;

FIG. 2 is a perspective view of a dummy of the wafer temperature detection device;

FIG. 3 is a cross-sectional view taken on line III-III of FIG. 2;

FIG. 4 is an enlarged perspective view of assistance in explaining the dummy disposed on a rotating disk of the ion implanter;

FIG. 5 is a perspective view of assistance in explaining a mounting device for holding the dummy;

FIG. 6 is a view taken in the direction of the arrow A shown in FIG. 5

FIG. 7 is a view taken in the direction of the arrow B shown in FIG. 5; and

FIG. 8 is a cross-sectional view of assistance in explaining a modified dummy and mounting device.

### DETAILED DESCRIPTION OF THE EMBODIMENTS

The embodiments of this invention will be described below with reference to the accompanying drawings.

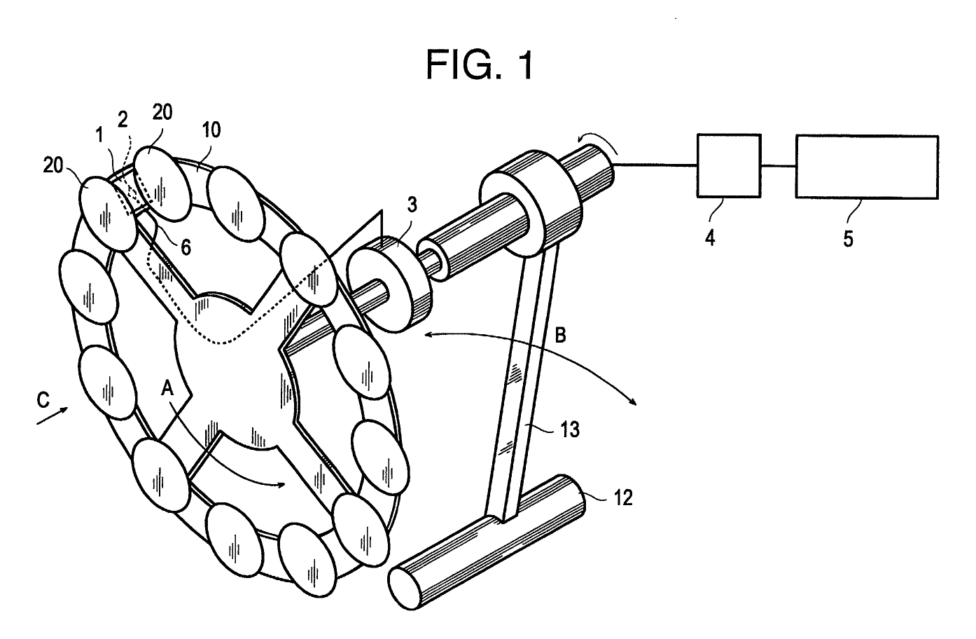

The wafer temperature detection device includes a dummy 1 and a temperature detector 2 as shown in FIG. 1. The dummy 1 is disposed on a rotating disk 10 where a plurality of wafers 20 are disposed to which ions are implanted in an ion implanter. The temperature detector 2 is provided in the dummy 1. The disk 10 is rotatably supported by the rotating shaft 11. The rotating shaft 11 is disposed in the center of the disk 10 and connected to an oscillating shaft 12 through an arm 13. The disk 10 not only rotates in the direction of the arrow A but also oscillates within a certain angle range shown by the arrow B. The overall basic constitution of the ion implanter, the rotating mechanism and the oscillation mechanism of the disk 10 are the conventional ones so that their descriptions are omitted.

The wafers 20 are posed toward the irradiation direction of the ion beam while disposed on a ring-shaped portion of the disk 10.

The dummy 1 for the wafer temperature detection is disposed below the space between adjacent wafers 20. A portion of the surface of the dummy 1 is exposed to the ion beam. A line 6 of a thermocouple 2, which is the temperature detector, is connected to a voltmeter 4 via a slip ring 3. More specifically, the line 6 of the thermocouple 2 is attached on the backside of the disk 10 and is guided to the slip ring 3. The line 6 is further attached to the arm 13 and is guided to the volt meter 4 provided on the outside of the ion implanter. The signal of the voltmeter 4 is inputted into a control device 5 such as a computer to display the temperature, while it is also used for the temperature control of the ion implanter.

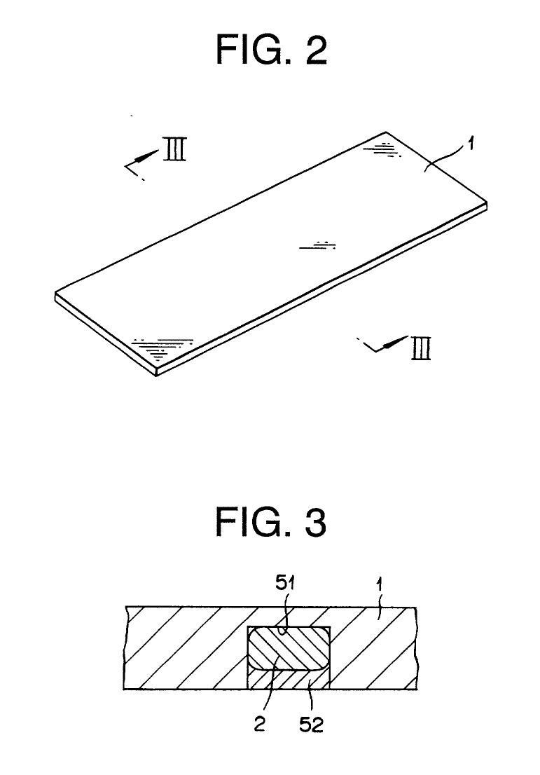

The dummy 1 is made of a material substantially identical to that of the wafers 20. The dummy 1 has an oblong rectangular shape as shown in FIG. 2, and its size is such that it is suitable for being disposed between adjacent wafers 20. As shown in FIG. 3, a recess 51 is formed on the backside of the dummy 1. The thermocouple 2 is sealed into the recess 51 with a sealing material 52. A material that releases little gas in a vacuum environment, is stable in the operating temperature range, and does not release dusts is preferable as the sealing material 52. Ceramic adhesive is suitable for the purpose.

Although it is preferable that the material of the dummy 1 is substantially identical to that of the wafers 20, it is not necessary to match all the characteristics such as impurity quantities and conductivity (p-type or n-type). For example, if the wafers 20 are made of a silicon single crystal, the dummy 1 is preferable to be cutout into the required rectangular shape from a silicon single crystal. If the wafers 20 are made of a compound semiconductor such as GaAs, it is preferable that the dummy is formed by cutting out a compound semiconductor into the required rectangular shape.

The thickness of the dummy 1 does not have to be the same as that of the wafers 20. This is because the effect of the thickness difference can be correctable by using a calibration chart as described later. If a certain layer such as an oxide layer is formed on the wafers 20, it is preferable to use the dummy 1 with the same layer. Since the effect of the layer formation can also be correctable by using the calibration chart, the above is not necessary.

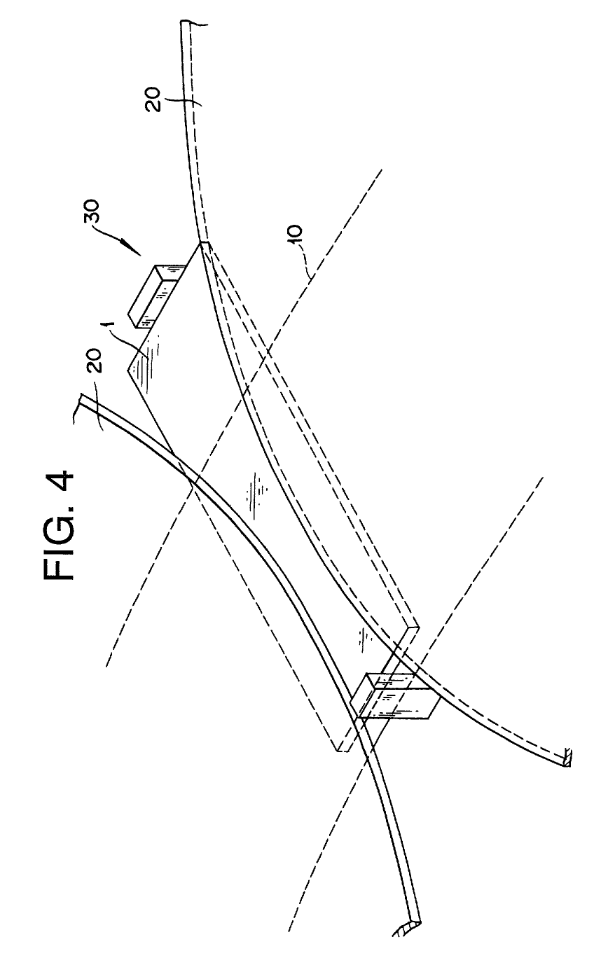

The dummy 1 is disposed below the space between adjacent wafers 20, and is mounted by a dedicated mounting device 30 to the disk 10 on which the wafers 20 are disposed, as shown in FIG. 4. More specifically, the dummy 1 is disposed slightly below the wafers 20 so that it would not interfere with the wafers 20. The surface of the dummy 1, which is exposed to the ion beam, is mirror-finished same as the wafers 20.

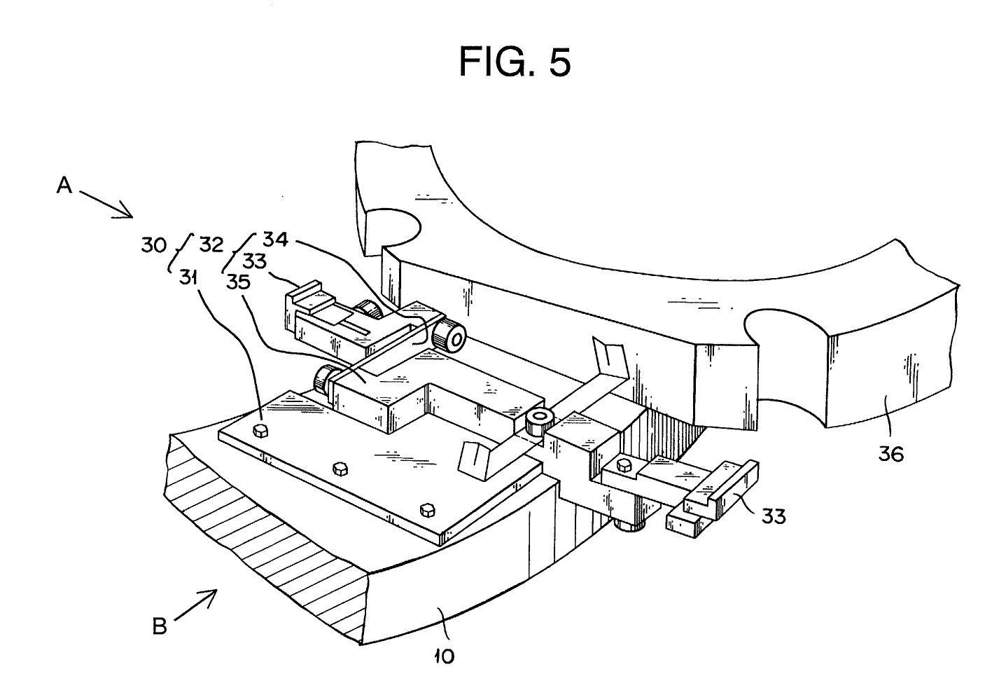

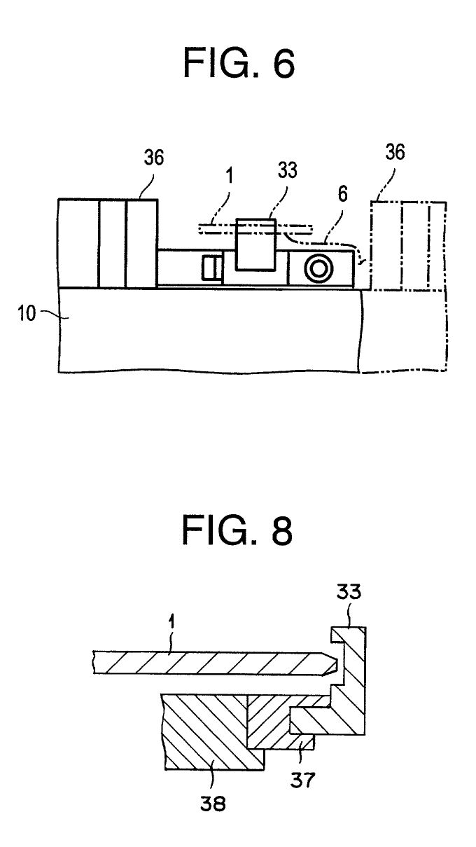

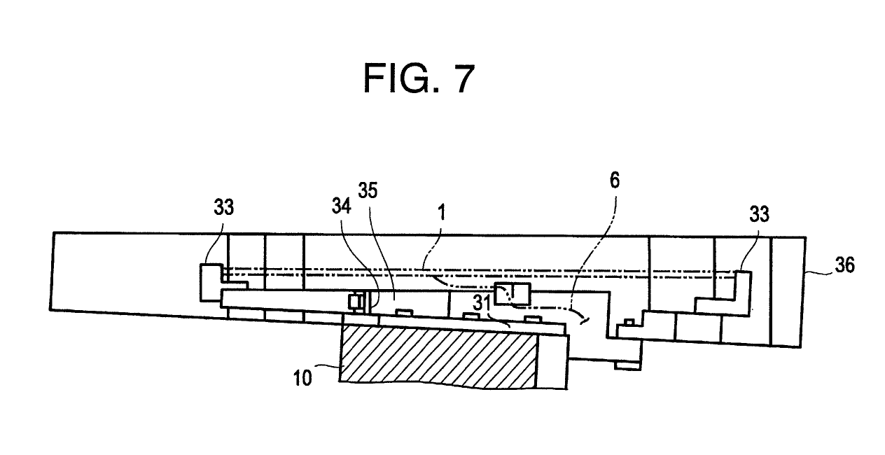

The mounting device 30 has a support base 31 and a clamp unit 32 as shown in FIGS. 5 through 7. The support base 31 is used to attach the mounting device 30 to the disk 10. The clamp unit 32 is disposed on the support base 31 and has a pair of nipping parts 33, a plate spring 34 and a clamp base 35. One of the nipping parts 33 is attached to the clamp base 35 via the plate spring 34 and is movable in the clamping direction.

The dummy 1 is attached to the mounting device 30 pinched by the nipping parts 33 using the spring force of the plate spring 34. Due to such a constitution, the thermal expansion of the dummy 1 caused by the temperature increase due to the irradiation by the ion beam will be absorbed by the plate spring 34. Therefore, the dummy 1 is prevented from cracking and chipping. It is also possible to attach the other of the nipping parts 33 to the clamp base 35 via a plate spring. The item identified as 36 is the holder of the wafer 20.

Since the dummy 1 is disposed between the wafers 20 and is irradiated with the same strength of ion beam under the same environment as the wafers 20, it becomes heated the same way as the wafers 20.

What must be reminded in measuring the temperature using the dummy 1 is heating by the ion beam and heat transfer since an operational environment of the dummy 1 is under a vacuum condition. Specifically, the heat generated by the ion beam is transmitted through the nipping parts 33 and the clamp base 35. As a result, the temperature of the dummy 1 drops. In order to prevent this, it is preferable to use a constitution such as shown in FIG. 8. More specifically, it is preferable that the end surface of the dummy 1 has a shape that minimizes its contact area with the nipping parts 33. Further, it is preferable that the nipping parts 33 have the shapes that the dummy 1 contacts only the nipping parts 33 and does not contact other members 37 and 38.

Next, the preparation of the calibration chart that is used for the temperature detection will be described.

A wafer is used as another dummy. The backside of the dummy wafer has a recess where a thermocouple is sealed in as in the case of the dummy 1. The dummy wafer is disposed at a specified position of the disk 10 as in the case of the wafers 20, and the dummy 1 is disposed at a specified place between the adjacent wafers 20. Next, the voltage change of the thermocouple attached to the dummy wafer and the voltage change of the thermocouple 2 attached to the dummy 1 are measured. Based on the results of these measurements, a calibration chart is prepared for converting the voltage change of the thermocouple 2 of the dummy 1 to the voltage change of the thermocouple of the dummy wafer. Once it is established, the temperature of the wafers 20 can be detected during the actual operation based on the voltage change of the thermocouple 2 of the dummy 1 referring to the calibration chart.

The relation between the output voltage of the thermocouple and the temperature is an intrinsic property of the thermocouple, so that it is possible to calculate temperature from the output voltage of the thermocouple. In case of the thermocouple for temperature detection available on the market, the data of the relation between the output voltage and temperature is provided by the vendor and such data can be used for this purpose. It is also possible to measure the actual relation between the voltage change of the thermocouple and temperature by causing the temperature change of the thermocouple. The preparation of the calibration chart and the conversion from the voltage to temperature can be performed by the computer 5.

Since the size of the wafers 20 and the size of the dummy 1 are not the same, the heat capacity of the wafers 20 and the heat capacity of the dummy 1 are different. However, the calibration chart can eliminate the effect of the difference in the heat capacity for performing accurate temperature detection.

As described above, the wafer temperature detection device includes the dummy of the substantially identical material as that of the wafers on the rotating disk where wafers are disposed to have ions implanted in the ion implanter, and the temperature detector provided on the dummy. Therefore, the temperature of the wafers is accurately detected in situ based on the temperature of the dummy measured by the temperature detector on the backside of the dummy. It makes it possible to control the internal temperature of the ion implanter accurately, which has hitherto been difficult due to its reliance on the radiation thermometer, by using the detection temperature.

The dummy is so disposed under the space between the adjacent wafers as to be exposed to the ion beam. The dummy does not affect the arrangement of the wafers and the number of the wafers that can be disposed on the disk. Therefore, the productivity does not change.

Moreover, a calibration chart can be prepared for converting the temperature of the dummy to the temperature of the wafers if a dummy wafer of the same shape as the wafers is used. Thus, the temperature of the wafers can be more accurately detected.

Furthermore, as the temperature detector is disposed in the recess formed on the backside of the dummy, the dummy temperature can be more accurately detected.

It is obvious that this invention is not limited to the particular embodiments shown and described above but may be variously changed and modified without departing from the technical concept of this invention.

For example, the oblong rectangular dummy is disposed below the space between the adjacent wafers in this embodiment. However, it is also possible to use the dummy wafer used for the preparation of the calibration chart as the dummy for the temperature detection as well. More specifically, the dummy wafer disposed at one of the positions on the rotating disk as the wafers are to be disposed can be used to measure the temperature of the wafers during the actual operation. In such a case, the calibration chart is not needed.

Further, the entire disclosure of Japanese Patent Application No. 11-110005 filed on Apr. 16, 1999, including the specification, claims, drawings and summary are incorporated herein by reference in its entirety.

What is claimed is:

1. A wafer temperature detection device for an ion implanter comprising:
a dummy disposed on a rotating disk where wafers are disposed to have ions implanted in the ion implanter, said dummy made of an substantially identical material as that of the wafers; and
a temperature detector provided on said dummy.

2. A device as claimed in claim 1, wherein said dummy is so disposed on the disk as to be exposed to an ion beam through a space between the wafers.

3. A device as claimed in claim 1, wherein said dummy is a wafer with an identical shape as the wafers, has a mirror-finished surface, and is so disposed on the disk that the surface is exposed to an ion beam.

4. A device as claimed in claim 1, wherein said dummy has a recess formed on its backside and said temperature detector is provided in said recess.
